(19) United States
(12) Patent Application Publication
(10) Pub. No.: US 2007/0064883 A1
(43) Pub. Date: Mar. 22, 2007

(54) TECHNIQUES FOR SUSPENDED DELIVERY OF MESSAGES

(76) Inventors: Lawrence Rosenthal, Berkeley, CA (US); Robert Carr, Foster City, CA (US); Keith Klemba, Palo Alto, CA (US)

Correspondence Address: BEYER WEAVER LLP, P.O. BOX 70250, OAKLAND, CA, 94612-0250, US

(21) Appl. No.: 11/458,960

(22) Filed: Jul. 20, 2006

Related U.S. Application Data
(60) Provisional application No. 60/701,753, filed on Jul. 21, 2005.

(51) Int. Cl. H04M 1/64

(52) U.S. Cl. 379/67.1

(57) ABSTRACT

Methods and apparatus are described for creating, scheduling and delivering messages.

### RELATED APPLICATION DATA

The present application claims priority under 35 U.S.C. 119(e) to U.S. Provisional Patent Application No. 60/701,753 for A METHOD FOR SUSPENDED DELIVERY OF MESSAGES filed on Jul. 21, 2005 (Attorney Docket No. ROSNP001X1P), the entire disclosure of which is incorporated herein by reference for all purposes. The present application is also related to copending U.S. patent application Ser. No. 10/964,175 for SYSTEM FOR COMPUTER-BASED, CALENDAR-CONTROLLED MESSAGE CREATION AND DELIVERY filed on Oct. 12, 2004 (ROSNP001), the entire disclosure of which is incorporated herein by reference for all purposes.

### BACKGROUND OF THE INVENTION

The present invention relates generally to messaging and, in particular, to methods and apparatus for generating and scheduling delivery of messages via a variety of communication media.

People keep track of appointments and other professional or social obligations in a variety of ways. The available solutions include the traditional (e.g., paper calendars, personal assistants), as well as a bewildering array of electronic devices and software (e.g., desktop calendar software, handheld computing devices, etc.). Some electronic solutions include the capability of generating alerts for impending appointments. However, many such solutions do not communicate with the user in one of the most clear and effective ways, i.e., by telephone.

People also employ a wide variety of messaging solutions to communicate with each other including, for example, email, instant messaging, voice mail, etc. However, these solutions provide only the most rudimentary capabilities for message creation, and typically do not allow the user to schedule delivery of the message to a variety of different device types.

It is therefore desirable to provide messaging solutions by which a user can flexibly create and schedule delivery of messages which are then communicated to the user at the appropriate time via any of a variety of communication channels.

### SUMMARY OF THE INVENTION

According to the present invention, methods and apparatus are provided by which individuals may generate and schedule the delivery of messages which include audio components which are played over a communication device at the scheduled time. According to specific embodiments, methods and apparatus for creating, scheduling and delivering messages are provided. According to one embodiment, computer-implemented methods and apparatus are provided for facilitating replies to messages. A first message from a sender is presented to a recipient via a communication device. In conjunction with presentation of the first message, a reply option is provided to the recipient by which generation of a reply message directed to the sender may be facilitated. In response to selection of the reply option by the recipient, generation of at least a portion of the reply message by the recipient is facilitated via the communication device including generation of an audio component of the reply message.

According to another specific embodiment, computer-implemented methods and apparatus are provided for handling collisions in a system for delivering suspended messages. A plurality of messages is stored for delivery to a plurality of recipients. Each of the messages has a delivery time associated therewith at which the associated message is to be presented to the corresponding recipient. Where presentation of a first one of the messages to a first one of the recipients at the associated delivery time will result in a conflict with a second one of the messages directed to the first recipient, the first and second messages are presented to the first recipient sequentially.

According to yet another specific embodiment, computer-implemented methods and apparatus are provided for providing information regarding pending messages in a system for delivering suspended messages. The system stores a plurality of messages for delivery to a plurality of recipients. Each of the messages has a delivery time associated therewith at which the associated message is to be presented to the corresponding recipient. A first one of the recipients is enabled to retrieve pending message information representing a first one of the messages directed to the first recipient. The pending message information includes the delivery time associated with the first message, but does not include message content associated with the first message.

According to a further specific embodiment, an electronic system is provided for delivering suspended messages. The system includes at least one holding system operable to store a plurality of messages for delivery to a plurality of recipients. Each of the messages has a delivery event associated therewith occurrence of which results in the associated message being presented to the corresponding recipient. Each holding system is further operable to detect changes in conditions affecting presentation of selected ones of the messages which occur between creation of the selected messages and occurrence of the corresponding delivery events, and facilitate presentation of the selected messages in a manner reflecting the changes in conditions.

A further understanding of the nature and advantages of the present invention may be realized by reference to the remaining portions of the specification and the drawings.

### BRIEF DESCRIPTION OF THE DRAWINGS

FIG. 1 is a simplified network diagram illustrating some exemplary devices and networks with which embodiments of the present invention may be implemented.

FIG. 2 is a flowchart illustrating operation of a specific embodiment of the invention.

FIGS. 3a and 3b depict exemplary login and account management interfaces for use with a specific embodiment of the invention.

FIGS. 4a and 4b depict exemplary calendar interfaces for use with a specific embodiment of the invention.

FIG. 5 depicts an exemplary existing message interface for use with a specific embodiment of the invention.

FIG. 6 depicts an exemplary new message interface for use with a specific embodiment of the invention.

FIG. 7 depicts an exemplary contact interface for use with a specific embodiment of the invention.

FIGS. 8 and 9 are simplified representations of a network environment and related system components suitable for practicing specific embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the invention are described below with reference to a messaging platform hosted on the World Wide Web which enables users to generate messages, schedule delivery of the messages, and specify phone numbers to which the messages are to be transmitted. It should be noted that the described embodiments are merely exemplary and that a wide range of variations are within the scope of the invention. For example, at least some of the functionalities described below may be implemented on a computing device associated with the user, e.g., in a desktop application, plug-in, rich client, etc. So, while a hosted platform provides some advantages in terms of scalability and efficiency, the present invention is not so limited.

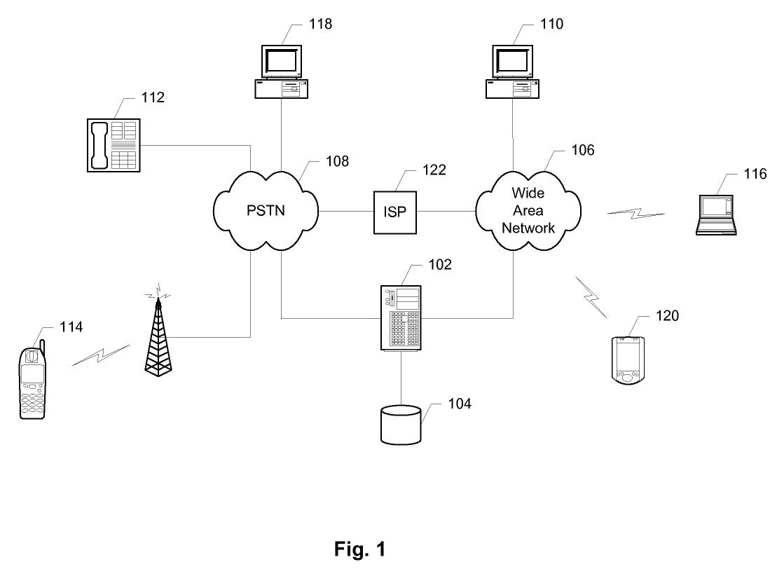

Referring now to FIG. 1, an exemplary network diagram is provided which illustrates at least some of the devices and modes of communication by which embodiments of the present invention may be practiced. It will be understood that these exemplary devices and modes of communication are by no means exhaustive. Server 102 and associated data store 104 represent a hosted messaging platform which may enable the various messaging functionalities of the invention. The hardware and operational details of server 102, data store 104, and the other devices and networks of FIG. 1 are not described herein as they are within the knowledge of one of ordinary skill in the art. It is sufficient to note that the functionalities of the present invention are implemented using computer code which is stored in and executed by one or more of the devices shown.

Server 102 (which may represent multiple devices) is connected to a wide area network 106 (e.g., the Internet) and a public switched telephone network (PSTN) 108. As will be described in greater detail below, a user of desktop computer 110 can access the web interfaces of server 102 via the Internet, and generate and schedule delivery of a message which is later transmitted by server 102 to a conventional telephone 112. Various other input and output channels for effecting the basic messaging paradigm of the invention are also contemplated.

For example, a message generated in the system could be transmitted to any of wireless handset 114, laptop 116, desktop 118, and handheld computing device 120. In addition, the generation and scheduling of messages may be accomplished using any of the devices shown. For example, desktop computer 118 may access the web interfaces of server 102 via PSTN 108 (i.e., using a modem), Internet Service Provider (ISP) 122, and network 106. Either of laptop 116 and handheld device 120 may also interact with server 102 via network 106. Even phones 112 and 114 may be employed to generate and schedule messages via PSTN 108 using their associated keypads and any suitable software at the server side (e.g., touch tone and/or voice recognition).

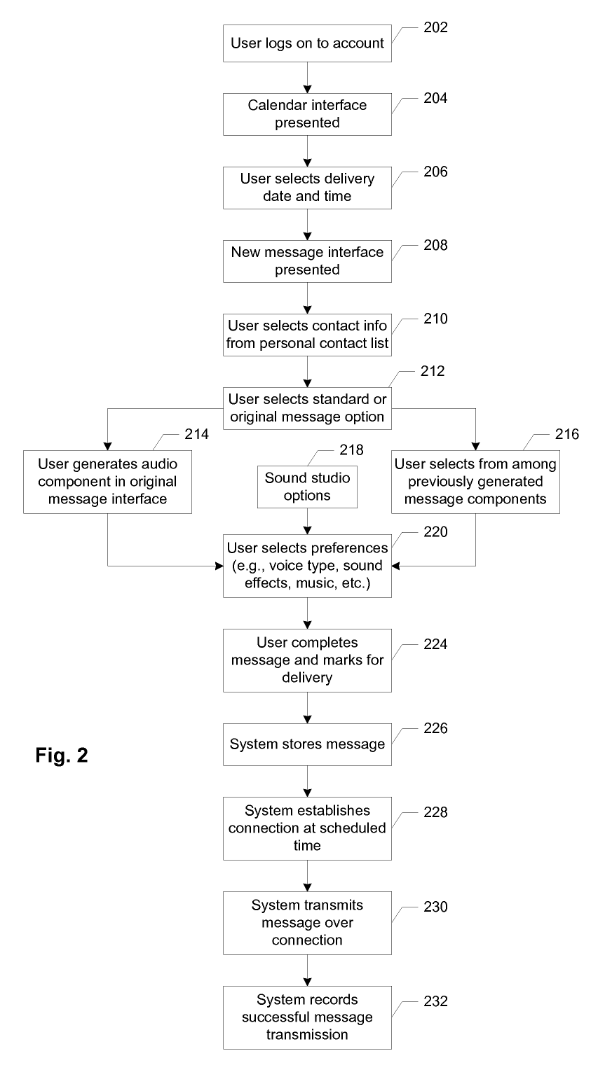

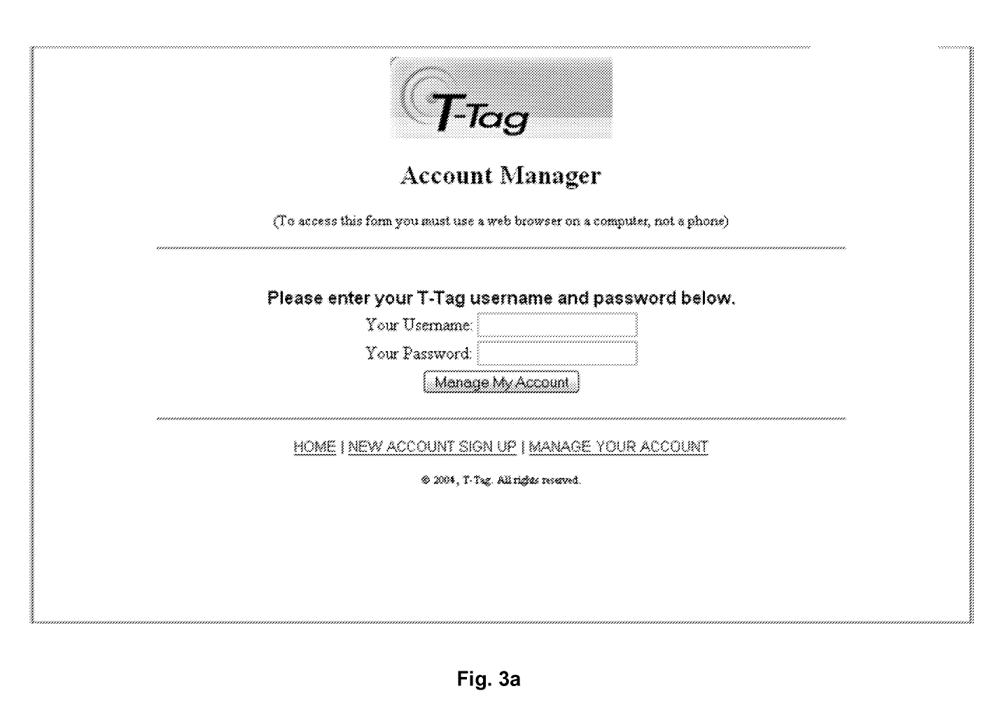

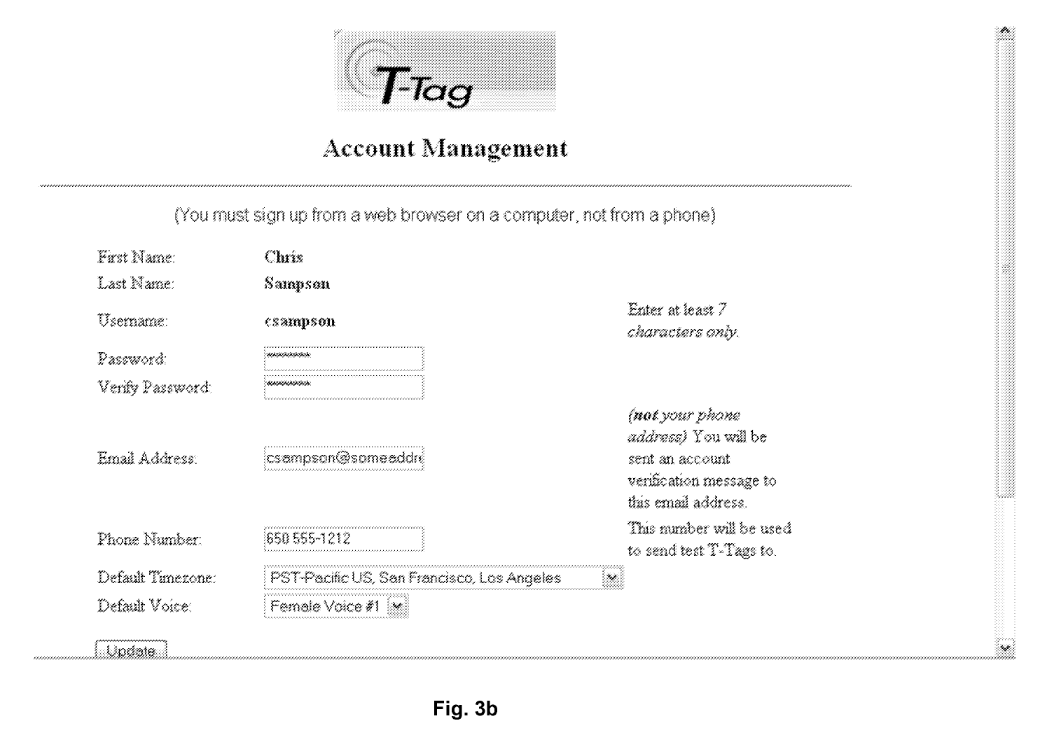

An exemplary method for generating and scheduling delivery of a message will now be described with reference to the flowchart of FIG. 2 and the exemplary web interfaces depicted in FIGS. 3a-7. Access to the system may be controlled with user names and/or passwords. Each user sets up an account using any conventional approach. By then entering the correct user name and password from their computer (e.g., using the exemplary login interface of FIG. 3a), access to the user's account which may include a personalized set of web interfaces is provided (202).

Associated with each user's account is a user profile which may be directly entered by the user upon setting up the account as shown in the exemplary Account Management interface of FIG. 3b. Alternatively, at least some of the information in the user profile may be derived from preexisting information such as an electronic business card, or a preexisting user profile or account associated with a web site or portal. The user's account also includes an associated contact/address book which includes contact information to which messages generated in the system may be directed. This information may also be derived from preexisting sources such as, for example, a Microsoft Outlook address book. Preferences or preferred settings may also be associated with a user's account and might include, for example, a default time zone (for the scheduling of messages), a default phone number for message pre-listening, a default phone number for reply messages, a save to archive function (which may be the default), etc.

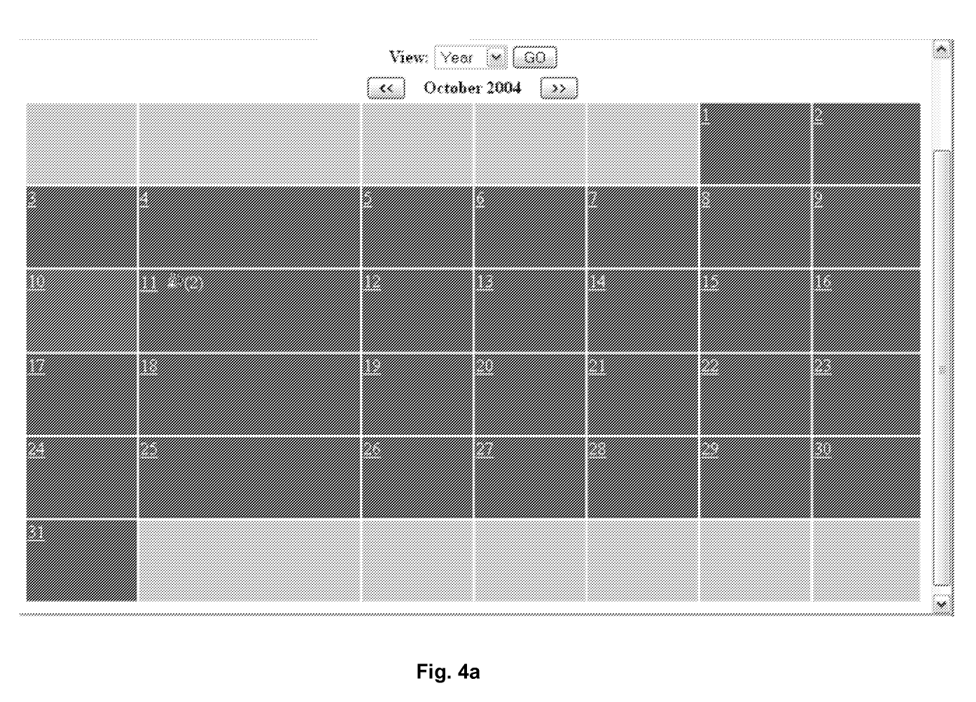

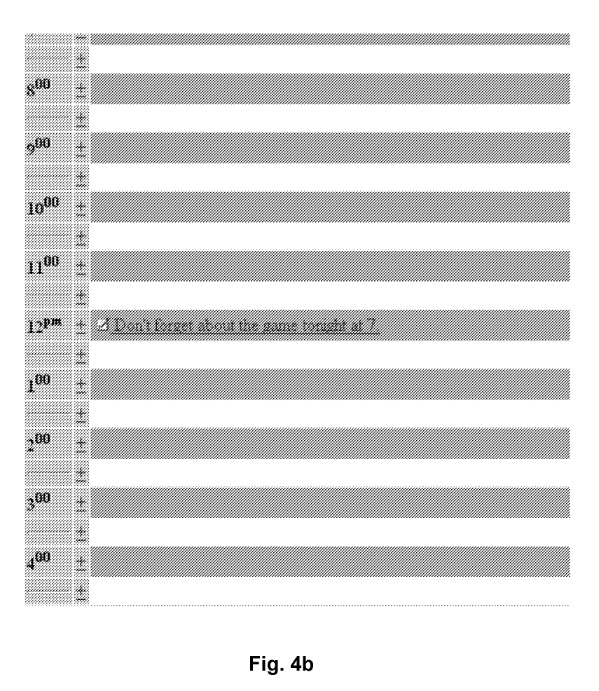

According to some embodiments, when a user logs into his account, one or more calendar interfaces are presented through which the system's functionalities may be accessed (204). As with many calendars (e.g., Outlook) there may be yearly, monthly (e.g., FIG. 4a), weekly, and daily (e.g., FIG. 4b) views. Any pending (i.e., previously scheduled) messages are indicated on the different views in a manner appropriate to each view. For example, a monthly view might have a number on a particular date indicating the number of messages scheduled for delivery on that date. Alternatively, a daily view might have each message indicated in a time slot with some associated text relating to the nature of the message. According to one embodiment, for recurring messages, only the next scheduled message may be shown.

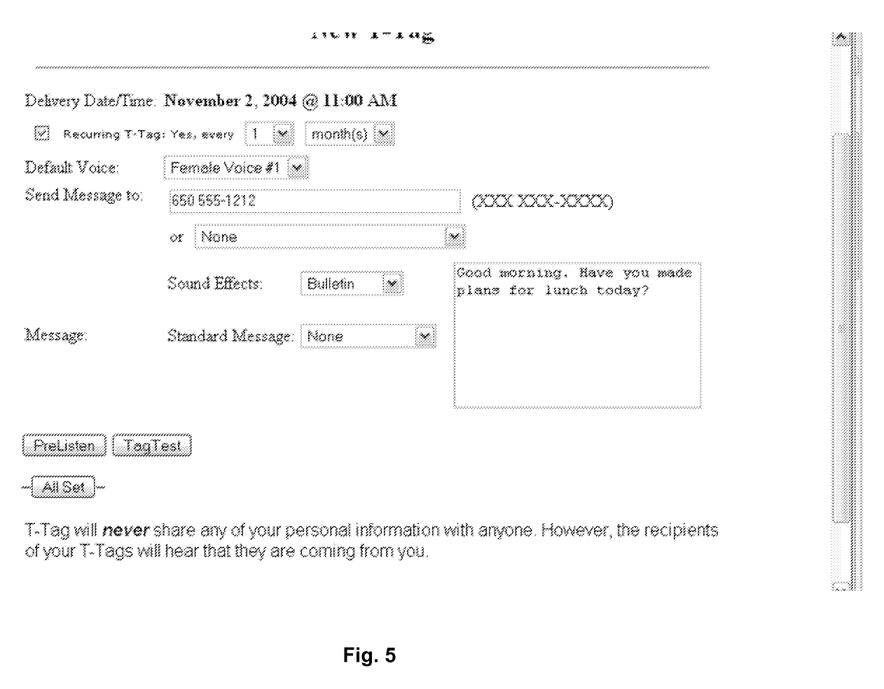

The user may select any of the pending messages to obtain more detailed information about the selected message including, for example, options to preview the message, or edit the selected message in some regard. The detailed information may be presented using a message generation interface (e.g., as shown in the interface of FIG. 5) in which the message was originally generated with the fields already populated with the message details. According to some embodiments in which the pending messages include messages directed to the user by another user, the user's options relating to the message may be limited, e.g., the user may not be able to edit such messages. When a user selects a message for editing, the message is pulled from the delivery queue to prevent the message from being delivered while it is being edited.

According to at least one embodiment, the user may view pending messages in a queue interface which lists the pending messages in the order in which they are scheduled for delivery. As with the calendar interface described above, selection of one of the messages may provide more detailed information or enable options (e.g., preview or edit) relating to the selected message.

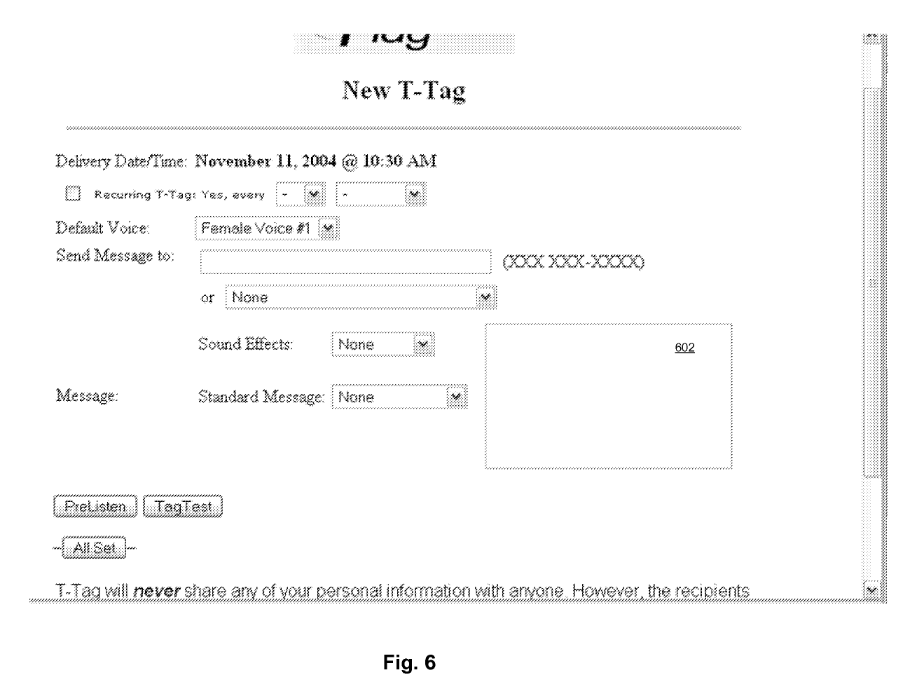

To generate and schedule a new message, the user navigates to a desired location in the calendar and selects a day and a time (206), in response to which a new message generation screen (e.g., the interface of FIG. 6) is presented (208). As shown, the delivery date and time fields are populated based on the selection made by the user in the calendar interface. This information may then be manually altered by the user if desired. Other modes of specifying the message delivery time are also contemplated including, for example, recurring messages (e.g., the first Friday of each month), and some time period in the future (e.g., 10 days from today).

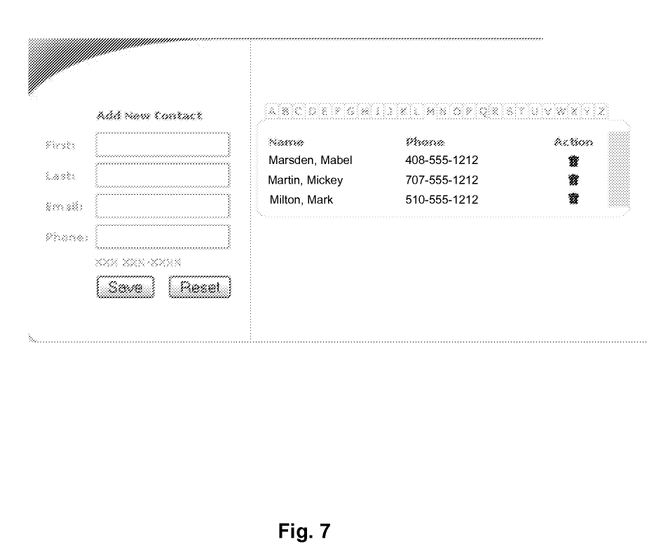

The user then specifies contact information to which the message is to be delivered. The contact information may take many forms. For example, the user may specify a phone number corresponding to a conventional phone or a wireless handset. Alternatively, the user may specify an email address to which the message is to be delivered. The user may also specify a network address or identify an IP phone to which the message is to be transmitted. In any case, the contact information may be derived from any of a variety of sources including, for example, an existing personal contact list or database (210) on or available to the user's device, e.g., a Microsoft Outlook address book. An exemplary contact interface is shown in FIG. 7. According to specific embodiments, multiple recipients of a single message may be specified.

It should be noted that, depending on the device with which the user is interacting with the system, the specification of delivery time, contact information, and other message parameters may be accomplished in a variety of ways. For example, if the user is generating and scheduling the message from a conventional or cell phone, the relevant information may be derived through the use of touch tone or voice recognition software.

The message may contain one or more audio components which may be delivered over a variety of networks or connections to a communication device. The user may select from among available components and/or create original components (212). According to one embodiment, an original audio component is generated from words entered by the user during the message generation process (214). The words may be entered by the user in a variety of ways depending on the nature of the interface or device from which the user is generating the message. According to various embodiments, the user enters the words as text. This may be done using a text box in a web interface (e.g., text box 602 in the interface of FIG. 6), a phone keypad (e.g., SMS text messaging), voice recognition software, an email message, etc. According to other embodiments, the words are captured by recording the user's voice, e.g., using a microphone associated with a desktop computer or over a phone connection with the user speaking into the handset.

Such original audio components and any previously generated audio components (discussed below) may take any of a variety of forms suitable for particular applications. That is, such audio components may be stored using any suitable analog or digital recording technique and format. Examples of such techniques and formats include, but are not limited to, .wav (Wave file), .mp3 (Mpeg 3 file), and .ram (Real Audio streaming file).

The user may also have the option of selecting from among a plurality of previously generated audio components (e.g., music, sound effects, standard messages) for inclusion in the message (216). This inclusion may take the form, for example, of mixing, prepending, or appending the previously generated component to an audio component generated by the user. Such previously generated audio components may also include prerecorded reminders or alerts, e.g., “You have a doctor's appointment at 3 pm today.”

Standard message types (e.g., appointment reminders, wake-up calls, birthday greetings, etc.) may include various previously created components which may be used “as is,” or which may be customized. For example, selection of a particular message type might result in presentation of a template to the user in which the user may enter various specific customizations (e.g., components to be included, voice type, recipient's name, recipient's phone number, etc.).

According to some embodiments, the message being delivered includes an initial announcement identifying the message as a reminder or an alert. This announcement may also identify the sender of the message, e.g., “I have a message from Larry.” Additionally, the announcement might also indicate the intended recipient of the message, e.g., “I have a message for Bob from Larry.” According to various embodiments, the sender or recipient could be identified, for example, from the contact information or by the user in the message generation interface.

According to a specific embodiment, the user is provided a premium service option which includes access to sophisticated sound studio software (218) which enables the user to create highly produced messages with virtually any desired component, e.g., originally composed music. According to a more specific embodiment, such software would include the capability of generating multiple tracks (e.g., Apple's Garage Band) and the capacity to compose music for instruments and/or voice. Such software may also enable a variety of capabilities including, for example, the integration of voices, music sound effects, user-created sounds, and standard messages in original messages. According to one embodiment, different voices may be embedded in a single message to simulate dialogue. Such software may also be employed for the customization of preexisting message components.

In addition, a premium service option could be provided in which the user can select his or her own voice. According to such an implementation, the user could be prompted to record several “training” phrases from which a sufficient number of phonemes or voice samples may be derived to generate a wide range of messages. Alternatively, the user may be given the option of directly recording messages in his or her own voice. Such an approach is advantageous, for example, in contexts in which the message originator is using a handset.

According to some embodiments, the audio component corresponding to the words entered by the user is generated using a text-to-speech conversion engine which may, for example, be any of Natural Voices (AT&T), Conversation Server (Conversay), DecTalk (DecTalk), Elan TTS (Elan Informatique), Nuance Vocalizer (Nuance), and ViaVoice Outloud (IBM). The text may be entered in a variety of ways, some of which depend on the device and/or interface employed by the user to generate and schedule the message. For example, as discussed above, a simple text entry box may be used in an interface on a desktop or laptop computer. On the other hand, if the user is employing a wireless handset, text may be entered using the handset's keypad and transmitted using an SMS text messaging protocol. For devices which support handwriting recognition, the text may be entered using the device stylus. Embodiments are also contemplated in which the text is entered and delivered to the system using an email message.

According to some embodiments, the user may select from among a variety of voice type options and other preferences to customize the sound of the message (220). According to one embodiment, a voice matrix approach is employed. On one side the user selects gender and age, e.g. young woman, and on the other, certain emotions or voice characterizations, e.g., sultry, serene, stern, anxious, etc. So, for example, a user might select an anxious old man by setting the two sides of the matrix. The myriad possibilities for such options are understood. With respect to previously generated audio components, various user preferences relating to sound effects and voice types may also be specified.

According to one implementation, the audio component(s) of a message may not be created at the time the user enters the message particulars in the new message interface (e.g., the interface of FIG. 6). Instead, the audio components (and particularly the text-to-voice components) for multiple messages may be periodically created in a batch. That is, the system can periodically determine, e.g., every few minutes or every hour, whether there are any pending messages for which audio components need to be generated. If so, the necessary audio components are generated. Alternatively, audio components could be generated only for messages scheduled to be delivered in an upcoming time period, e.g., for all messages to be delivered tomorrow. According to one embodiment, before each message is sent out, the system determines whether any necessary audio components have been generated and, if not, generates them.

Once message generation is complete, the user has the option of previewing or “pre-listening” to the message and making any desired changes. According to some embodiments, accurate translation from written text to speech may be further facilitated by, for example, prompting the user to clarify unclear text upon entry.

According to a specific embodiment, the user may activate a sound test feature (e.g., by selecting the PreListen button of FIG. 6) to play the message before marking it for delivery. Selection of this feature causes the audio portions of a message to be generated, hosted on the server, and played through the user's browser. According to a more specific embodiment, a .wav file is generated from the text entered by the user is sent by a text-to-speech engine.

According to another embodiment, the user may activate a message delivery test feature (e.g., by selecting the TagTest button of FIG. 6) to deliver and play the message over a designated device before marking it for delivery. Selection of this feature places the message in an immediate delivery queue which has its own dispatcher demon (operation of which is described below) which establishes a connection to the designated test device (e.g., the user's cell phone) and plays the message.

When the user is satisfied with the message, he may indicate that the message generation is complete by marking the message for delivery (224), in response to which the system stores some or all of the message components for delivery (226). As discussed above, the pending message may then be represented in any of a variety of interfaces, e.g., a calendar or a queue, from which the user may select the message for pre-listen or editing. According to one embodiment, the user has the option of archiving a completed message or any of its components in a personal archive by selecting an “archive” button or some equivalent mechanism.

According to a specific embodiment, pending messages in the queue (which may reside in server 104) may include text, time and date of delivery, and other accompanying data such as, for example, recurring notations, sounds, voice selection and other voice options. A unique ID and message status (e.g., Pend) is assigned upon delivery to the queue. Message order in the queue is defined by time and date of delivery. An audio slave demon (ASD) wakes periodically (the period being programmable). The ASD scans the queue to find new messages, i.e., messages for which the text and/or sound have not yet been converted to an audio file, i.e., messages with status=Pend. For each such message, the ASD passes a copy of the text and voice options to the text-to-speech engine (TSE). The TSE then generates an audio file (e.g., a .wav file) which is stored in server 104. The audio file is correlated with the corresponding message in the queue via its unique ID. The status of the message in the queue then changes to reflect that this process has been completed, e.g., the status is changed from Pend to Pend1.

When the delivery time arrives, a connection is established to the communication device(s) identified by the contact information associated with the message (228). This may mean establishing a phone connection to a conventional telephone or wireless device via their respective networks. Alternatively, it may mean establishing a TCP/IP connection to an IP phone or other communication software on a computer. It may also mean establishing a connection to an email server for transmission of the message as an email. The connection to the communication device may be established, for example, by a server hosting the message service or by a stand-alone machine over a modem.

According to a specific embodiment, a dispatcher demon (DD) wakes periodically (the period being programmable) and looks for all messages ready for delivery in the queue, i.e., messages for which status=Pend1 and for which the stipulated delivery time lies in a window defined relative to the current time, e.g., the current time plus or minus some defined duration (e.g. 2 minutes). According to a more specific embodiment, the DD intelligently orders the messages identified as ready for delivery based on any of a variety of parameters. For example, the DD may prioritize messages for which the stipulated delivery time is earlier than the current time. In general, the DD may refer any of a wide variety of parameters to effect the most efficient ordering of messages including, but not limited to, the number of messages currently pending in the queue, the size of particular messages, and the available call line resources.

Once the messages are ordered, the DD inserts each message at the appropriate time into the script of a Voice XML Server (e.g., Vocomosoft). The Voice XML server associates script and phone line, dials the specified phone number, and runs script using the .wav file associated with the message ID. The Voice XML server may also run sounds and any standard intro or ending messages. The Voice XML server then gives the message and results (e.g., connected, time out (N/R), hangup) back to the DD. The DD changes the status of the message to reflect this information and then returns the message to the queue.

According to one embodiment, the DD inspects to see if the message is recurring. If so, the DD determines the time interval until the next delivery, changes the delivery time and date accordingly, changes the message status to Pend and puts the message in the queue. The results of the message delivery attempt (e.g., connected, time out, or hangup) are recorded in the status or other field. According to one embodiment, the DD generates an email to the user recording results of message, and all DD actions are recorded in a log.

The message may be presented over the connection (230) in a variety of ways depending on the nature of the component(s) with which the message is constructed and the capabilities of the receiving device. For example, if the receiving device is a conventional or wireless phone, the audio component(s) may simply be played over the connection to the device. If the device supports text messaging (e.g., SMS), at least a portion of the message may be presented as text.

If, on the other hand, the receiving device is a computing platform of some kind, the message may be presented in a variety of ways. For example, if the platform has an IP phone or other voice communication software, the message may be played using such software. Alternatively, the message may be sent as an email which may include text and/or one or more appended audio components (e.g., a .wav file) which may be selected and played by the recipient. The email might also contain html with links to the audio components of the message (which may be stored, for example, on server 102).

In cases where the communication device is a real-time voice communication device, e.g., a conventional or wireless phone, the system may be configured to wait until someone answering the call speaks before delivering the message. In some cases, the communication device to which the message is directed is not available. Therefore, according to some embodiments, attempts to deliver the message are repeated until the message is delivered successfully, or until some programmable number of failures has occurred. In some implementations, attempts to deliver the message may be made to alternative communication devices and/or recipients specified by the user. In addition, a failure to deliver a message may also be communicated to the user or other appropriate party via any of the mechanisms described herein.

When the connection does not reach a live person, but instead reaches a voice mail box, embodiments of the invention may be configured to detect that a voice mail box has been reached, and then wait until the outgoing recording finishes before delivering the message.

According to some embodiments, the recipient of a message which is generated and delivered according to the present invention may take advantage of system functionalities. According to one such embodiment, the recipient of a message may replay a message by, for example, selecting a designated key on his phone keypad or speaking the word “replay” into the handset. Other options might include requesting a repeated later delivery of the message by selecting the later delivery time using touch tone or voice recognition.

When the system deems a message to have been successfully delivered to the receiving device, a system notification is generated to record the successful delivery (232). This notification may be employed by the system to delete the message from the user's queue, and/or to generate a notification (e.g., an email) to the user indicating successful delivery, etc.

Hosted messaging platforms implemented according to some embodiments of the invention may also provide a wide range of “back office” functionalities to facilitate system operation. For example, the number of messages generated and scheduled by each user could be monitored for a number of purposes, e.g., billing, load balancing, identification of spammers, etc. Such hosted platforms are also highly scalable, enabling many users to simultaneously generate messages, and being capable of transmitting many such messages substantially simultaneously.

Some systems designed according to the present invention may be subject to both traditional “nuisance call” problems and spam problems. Nuisance calls can be controlled by user contract language, by system monitoring (e.g., keying on repeated messages to the same number), and by appending system operator messages. Such system operation messages might, for example, instruct message recipients to contact the system operator in cases of nuisance calling. Spam-prevention can also employ appended messages, system-operator monitoring, and contractual limitations on users.

The foregoing description relates to four main activities: generating a message, scheduling delivery, establishing a connection, and transmitting the message. Further embodiments are described below relating to suspending communications between scheduling delivery and connecting to the recipient. Suspension of communications is carried out by what is referred to herein as a holding system. Such a holding system may be enabled, for example, in the system by a storage server, e.g., 102 and 104 of FIG. 1. Details regarding a number of attributes for exemplary holding systems designed in accordance with the invention are described below.

Specific embodiments herein describe a message being delivered to a single recipient. Several different ways of establishing a connection to the recipient are also discussed. According to some embodiments, a single message may also be delivered to multiple recipients. The handling and development of multiple recipients is described below.

In addition, the direction of message flow in some of the embodiments described herein is assumed to be from the originator to the recipient. However, as will be described, embodiments of the invention are contemplated in which a reverse message flow called a “reply” may be facilitated.

And as described above, events release suspended messages for delivery to their intended recipients. Specific techniques which may be employed to accomplish delivery of such messages are described below.

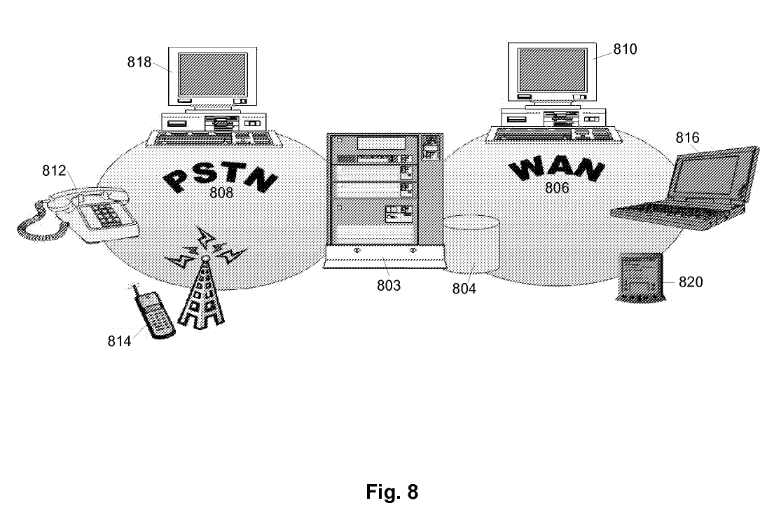

According to various embodiments of the invention, methods of delivering suspended messages (i.e., T-Tags) to recipients are enabled by a holding system, represented in FIG. 8 as a server 803 with an associated a data store 804. It is the responsibility of holding system 803 to store T-Tag requests awaiting their release to the recipient (e.g., any of 812, 814, 810, 816, 818, and 820). Holding system 803 may also be responsible for maintaining an audit trail and history of message handling for business and customer service processes.

According to specific embodiments of the invention, the holding system maintains the readiness of each T-Tag for delivery. Due to the relatively long period of time involved in suspended communications, changes may occur that could influence the T-Tag readiness (e.g., voicing systems, account balances, coding schemes, storage technologies, communication systems, and regulations). In addition, T-Tag readiness may be maintained even where it is not possible to predict the occurrence of the event releasing a T-Tag. Even in the case where the event is simply time, normally the steady approach should be well anticipated. However, the recipient might travel to a new time zone and suddenly as the recipient registers this change a T-Tag release event can be affected in such a way that the T-Tag must be released immediately. Likewise, in the case where the event is the arrival of a certain message, the approach of the event is completely unforeseen. Therefore, to deal with these various issues, the holding system proactively manages the readiness of each T-Tag in its care.

Implementation of the various functionalities of a holding system designed in accordance with the invention may be, for example, in a network accessible system comprising one or more physical devices (e.g., 803). Such functionalities may also be implemented in a distributed fashion, e.g., within client hardware (e.g., 810, 816, and 820). In addition, it could be implemented in a manner that combines both of these implementation schemes. The preferred embodiment is one that makes use of network attached systems that are always on and can be monitoring for events continuously.

Holding system 803 maintains a storage subsystem 804 that facilitates the message and accounting information for T-Tags and users. Storage subsystem 804 may represent both near-term and long-term storage systems. A complete call history may be maintained for each account long enough to satisfy legal accounting requirements.

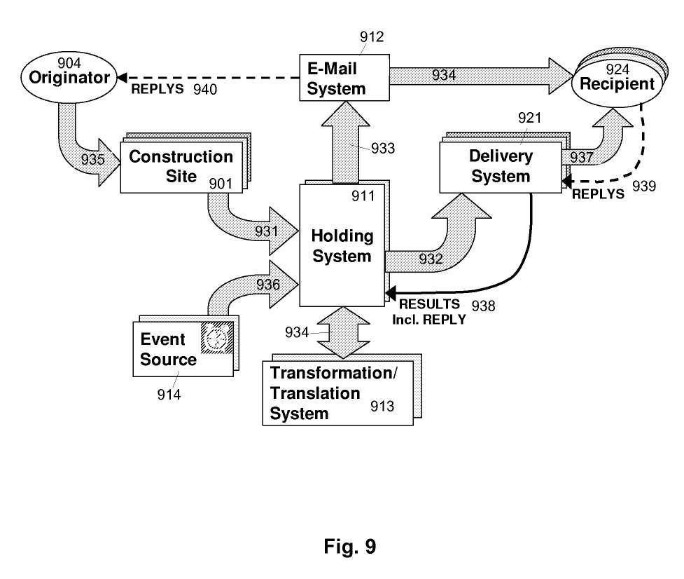

Referring now to FIG. 9, user account information may be securely held by the holding system 911 in the storage subsystem. Users may be given access to their own information for the purpose of updating and maintaining current profile information. As described above, the storage subsystem is also where the holding system stores pending T-Tag requests. The originator 904 of a T-Tag request can recall a pending T-Tag request and change any of its attributes, and even delete the request. As will be understood, the storage subsystem can be implemented in a variety of ways to facilitate performance, scalability, and economy. According to a particular embodiment, the storage subsystem is implemented as an attached disk array.

In addition to the storage subsystem, the method for delivering suspended messages to recipients may involve several other subsystems interacting with the holding system as illustrated in FIG. 9. Holding system 911 maintains access to a transformation-translation subsystem 913 which is operable to change the form of a message based upon the T-Tag request. For example, one embodiment involves transforming the message from text to voice. This transformation may also include encoding schemes dependent on delivery system(s) 921. The holding system selects the necessary transformation or translation function and processes the message through this service in order for the T-Tag to be in a ready state for the delivery system.

Another subsystem that holding system 911 may interact with is event source 914. Event source 914 represents a wide range of network based capabilities that can provide a mechanism for triggering an event that can be monitored to release a T-Tag upon its occurrence. An example of one such capability is embodied in a time based function that signals the occurrence of a moment in time or the expiration of a period of time. Event notification to the holding system may be either solicited or unsolicited. A given event may release as many T-Tags as are waiting for that event.

According to some embodiments, the holding system is operable to analyze suspended T-Tag requests to see how many messages would be released to any one recipient 924 at a time. For example, if more than one T-Tag is to be released upon the same event to the same recipient via a single-threaded delivery system, the holding system may be configured to forecast a message collision and to serialize the T-Tags so they can be delivered one at a time.

According to specific embodiments, each holding system (there may be several) can maintain relations with any number, e.g., 100's or even 1000's, of construction sites 901 to provide varying levels of supporting services through a network connected API. Such API's may be built using standard tools and languages well known in the industry (e.g., XML, RPC, SOAP). Such API's may, for example, support account level interaction wherein the holding system maintains all user account data. Alternatively, such API's may be configured to support only the fundamental suspended T-Tag request. In this latter approach the construction site could maintain all user data and could, for example, supply all the necessary information in a single T-Tag request interaction with the holding system.

The holding system may also maintain an association with one or more email subsystems 912 for the delivery of email-based T-Tags to recipients. The email delivery can be a backup delivery method for a failed alternate method, a duplicate follow-up message of a T-Tag delivered via an alternate method, or it may be the primary intended delivery method for a T-Tag. Interaction with the email subsystem may be accomplished via means well known in the industry. The holding system may also maintain an association with one or more delivery systems 921. This association and related functional activity is described in greater detail below.

The following description outlines a dataflow path with reference to FIG. 9 which enables a one-to-many delivery capability of T-Tags. A many-to-one capability is also discussed in the next section covering the reply capability mentioned above. It should be noted that the reply capability described is not necessarily limited to the context of systems for suspended or delayed delivery of messages, and that embodiments are contemplated in which such reply functionality is provided in a wide variety of messaging systems.

A T-Tag originator 904 makes connection to one of several T-Tag request construction sites 901 on the World Wide Web. There they construct a T-Tag request using their own information 935. When the T-Tag request form is completed the construction site establishes a connection with a holding system 911 and delivers the T-Tag request form 931. The site constructing the T-Tag request may support the ability to create lists of multiple recipients. These lists can then be included in the T-Tag request to allow the same message content to be delivered to multiple recipients. A single event releases the T-Tag to all recipients. According to some embodiments, if the event is based on time, release of a corresponding T-Tag may be sensitive to the recipient's time zone.

If a submitted T-Tag request 931 specifies multiple recipients 924 the holding system creates a copy of the T-Tag request for each recipient. Each copy may have some unique attributes of its own (e.g., spoken name, recipient phone number, email address, time zone, and voice selection). According to such an implementation, from this point on, each of these T-Tag requests is treated independently by the holding system.

Each T-Tag request is kept under the control of the holding system awaiting an event 936 to release it to a delivery system 921. Each one is managed in accordance with all the attributes of the holding system described previously. Based on a number of considerations (e.g., load balancing, capacity planning, technology timeframe, and delivery proximity) T-Tag requests may be moved around among distributed holding systems 911 while delivery is suspended.

Eventually, the holding system receives a release event 936 from any event source 914 available. This releases the actual T-Tag for delivery. The holding system may execute a final check to see if releasing this T-Tag is still authorized (e.g., recipient on do-not-call list, account balance too low, collision with another T-Tag to the same recipient, etc.). If any adjustments are need to the T-Tag they are made and the holding system releases the T-Tag to delivery system 921. Otherwise it may return the T-Tag request to the originator 904 via, for example, email system 912 marked as undelivered with the reason.

Proceeding to deliver the T-Tag, the holding system opens a connection to a selected delivery system 921 and sends the T-Tag 932. Upon receipt the selected delivery system delivers the T-Tag 937 to the intended recipient 924. The delivery system then communicates the results 938 of the delivery back to the holding system.

Consider the event source 914 for releasing T-Tags as the arrival of a moment in time. According to some implementations, T-Tag requests may have a system wide time limit attribute applied to them so that if no releasing event occurs before this time limit the T-Tag request is returned to the originator via email indicating the timeout.

The holding system receives a result 938 from the delivery system to conclude its monitoring of the T-Tag. Using this result the holding system may construct an email follow-up message 933 and deliver it to an email system 912. The email System, using standard services, delivers the follow-up email message 934 to the T-Tag recipient 924.

According to some embodiments, the ability to facilitate an optional recipient reply is provided. According to some of these embodiments, financial charges may be involved with such a reply capability. According to such implementations, a coordinated link to a valid active account may be provided. According to a specific embodiment, there are two ways to pay for a reply. In the first case the originator agrees to pay for the reply to a T-Tag he sends out. In the second case the recipient agrees to pay for the reply to a received T-Tag.

When a T-Tag request 931 is being generated at a construction site 901 the originator has the option to indicate that a reply is desired and that he is willing to pay for the costs of getting a reply. The T-Tag request also specifies what type of reply is desired (e.g., a T-Tag reply, an email reply, etc.). The holding system processes the T-Tag request 931 including the reply parameters. When the holding system receives the event to release the T-Tag it updates the reply authorization information in the T-Tag. If the originator is paying then the originator's account may be linked to the T-Tag reply. If the originator has not authorized payment for reply then recipient 924 is checked to see if he is a registered T-Tag user and has an adequate balance in his account, in which case the holding system links the recipient's account to the T-Tag reply.

The T-Tag reply account link may be presented, for example, in the T-Tag 932 delivered to delivery system 921. Reacting to this information delivery system 921 may form or include the necessary voice solicitation in the T-Tag 937 when it is delivered to the recipient. If the recipient responds affirmatively to the reply solicitation then the delivery system records the reply message 939 and delivers it back to the holding system along with the T-Tag delivery results 938. The holding system then follows the reply type request and sends the reply back to the originator by, for example, delivering it to the email system 912 as an email with a voice attachment 933 or as a T-Tag 932 scheduled for immediate delivery to the originator 904. If the email system is used it may use the email address of the originator to deliver the reply using standard email mechanisms 940 known to the industry. Note that according to a particular embodiment, if the reply is sent via T-Tag to the originator, it may automatically be followed up with an email indicating the status of the delivery of that reply to the recipient.

A special case exists when a reply is requested in a multiple recipient T-Tag. As described above, a single T-Tag request can be used to direct T-Tags to multiple recipients. Take for example the case where there are 10 recipients all in the same time zone such that they all get a T-Tag at the same time. If they all choose to reply, there would be 10 replies coming back into the holding system for immediate delivery to the originator. For the email Reply type this would not be a problem but for the T-Tag delivery it is. This problem however may be resolved by the holding system(s) using one or more of the following techniques.

According to one such technique, referred to herein as collision avoidance, one reply makes it out to the originator immediately and each subsequent one detects a collision and is backed off in time so as to allow the preceding T-Tag to complete before trying to deliver the next reply. This feature may be used in general to help avoid having the delivery system get a busy signal as it tries to establish a connection to the recipient while another T-Tag is being delivered.

This method of collision avoidance may further be extended to allow registered T-Tag users to see all the T-Tags scheduled to be sent to them in the future. According to some embodiments, only the date and time are revealed so as not to spoil the surprise of the message contents or the originator until it is actually delivered. This feature of allowing a user to know when he is going to receive a call is an advantageous aspect of some embodiments of the invention. Other information relating to pending messages might include, for example, message size, message type, the device to which the message is directed, the sender, etc.

This advantageous feature can be better understood in relation to the standard in-box/out-box convention of messaging. Conventional message system users have access to in-boxes and out-boxes which log their history of received or sent messages. In addition, users often have an out-box of messages they intend to send at a future time (often called “drafts” or the like). By contrast, and according to some embodiments of the present invention, another form of in-box, i.e., the “anticipatory in-box,” is introduced. That is, the anticipatory in-box logs messages, i.e., T-Tags, the user has been scheduled to receive but which have not yet been sent.

According to some such embodiments, the user may be enabled to alter parameters affecting presentation of such pending messages. For example, the user may delay the delivery time, or change the communication channel by which the message is to be presented (e.g., a different phone number), and/or the format of the message (e.g., from voice to email).

According to another embodiment, a personal voice library may be maintained to deal with multiple replies. With this feature reply messages are recorded and stored in the originator's voice library. If several replies have come in and are waiting in the voice library, the originator is contacted to facilitate delivery of the messages, e.g., the originator may be given the option of selecting the replies for delivery one at a time in any order, or in the order the replies were requested. This method also makes it possible to keep the originator's phone number confidential.

According to specific embodiments of the invention, the reply feature described herein may be employed to conduct custom surveys and, in particular, to gather responses to such surveys. Referring once again to FIG. 9, T-Tag originator 904 makes connection to one of several T-Tag request construction sites 901 on the World Wide Web. There he constructs a T-Tag request using his own information 935. If the originator wishes to ask the recipient one or more questions they may fill out an optional “template” section of the T-Tag request form. Such a template allows the originator to program a complex query for the recipient. For example, using such a template, questions may be based upon answers to preceding questions as the survey is delivered. When the T-Tag request form is completed the construction site establishes a connection with a holding system 911 and delivers the T-Tag request form 931.

When the T-Tag is delivered, the recipient 924 can answer the questions using, for example, voice responses or the telephone touch pad to send tones (e.g., DTMF tones) which would have prescribed meaning (e.g., 1 for yes, 2 for no, etc). These answers are collected by delivery system 921 and sent back to holding system 911 for delivery to originator 904 using the reply mechanism discussed above. If a survey is sent out to multiple recipients, then more than one reply will be coming back to the originator. In such cases, the holding system may be configured to aggregate the responses from replying recipients to produce a summary report of the results (e.g., 10 yes's, 15 no's).

According to specific embodiments of the invention, the delivery system(s) 921 may be configured to deal with several communications providers to normalize their call setup, message playback, message recording, and billing systems for uniform interoperation with the holding system. Communication providers can be as sophisticated as AT&T or as simple as a server with a dedicated modem bank. The set of all T-Tag delivery systems makes for a wide range of T-Tag delivery options and represents a scalable distributed solution capable of an extraordinarily large number of simultaneous outbound T-Tags.

Delivery system 921 is responsible for providing fast efficient delivery of T-Tags 932 and 937 released by holding system 911 to recipients 924. According to some embodiments, one or more XML RPC's may be provided to facilitate communication between the holding system(s) and the delivery system(s). This communication allows for all aspects of T-Tag delivery to be managed across this interface.

The delivery system may be configured to work closely with a service provider to manage calls (e.g., busy, call waiting, answer machines, call selections, hang-ups, recording voice replies). This may be accomplished in the delivery system using custom scripts and software designed to work with specific service providers to provide a uniform set of services to the holding system(s) and a uniform quality of service to recipients. In addition, according to some embodiments, it is possible to select specific delivery systems which are the most economical in connecting to the recipient (e.g., free local calls, free in-plan calls, volume rate discounting, shared modem pools, VoIP calls, audio instant messaging, etc.).

And while the foregoing description is focused on various vendors of voice delivery, other delivery forms are also contemplated. For example, an SMS-based text message delivery system may be employed in which the T-Tag is presented in text form transformed to be delivered via SMS to cell phones. According to further embodiments, T-Tags can be transformed into flash animations and delivered via RSS to recipients as news items. In addition, T-Tags can be a transformation of actual video with or without soundtracks (e.g., Princes Leia speaking via hologram to anyone who could help her; truly a vision of how T-Tags can talk to the future).

Delivery systems configured according to the invention may also be operable to process T-Tags according to a level of effort or quality of service expressed in a T-Tag request. For example, the level of effort specified for a T-Tag delivery can be expressed as simply “best effort” or as persistent as “exhaustive.” This ability to provide varying degrees of effort for successful delivery is unbounded over time and recorded experience with various recipients. Different levels of effort or qualities of service in the delivery of T-Tags may involve, for example, different numbers of attempts across one or a variety of different delivery systems depending on the level specified.

Delivery systems may also be configured to maintain independent attributes regarding T-Tag deliveries. For example, a delivery system may be configured to detect excessive calls to a particular recipient from a particular originator, thereby minimize stalking or nuisance calls.

And according to some embodiments, part of the interaction of the delivery system(s) with the holding system(s) may be to provide updated information regarding delivery rates and policies. In this way the holding system can, in turn, provide accurate estimated delivery costs to the originator for a given T-Tag request.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention are contemplated in which some portion of the functionalities described above are facilitated by the user's platform or device. Embodiments are also envisioned that take advantage of external application programming interfaces to integrate at least some of the functionalities described herein within interfaces with which users are already familiar. In addition, some or all of the described functionalities may be provided in conjunction with other services on a phone service carrier's web site.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for facilitating replies to messages, the method comprising:
presenting a first message from a sender to a recipient via a communication device;
in conjunction with presentation of the first message, providing a reply option to the recipient by which generation of a reply message directed to the sender may be facilitated; and
in response to selection of the reply option by the recipient, facilitating generation of at least a portion of the reply message by the recipient via the communication device including generation of an audio component of the reply message.

2. The method of claim 1 further comprising scheduling the reply message for immediate delivery to the sender.

3. The method of claim 1 further comprising facilitating generation of at least a portion of the first message by the sender including specification of a delivery time for the first message by the sender and generation of an audio component of the first message by the sender, the method further comprising storing the first message for delivery to the recipient at the delivery time.

4. The method of claim 3 wherein facilitating generation of at least a portion of the first message comprises enabling the sender to specify that the reply message is desired.

5. The method of claim 4 wherein facilitating generation of at least a portion of the first message further comprises enabling the sender to specify a message type for the reply message.

6. The method of claim 4 wherein facilitating generation of at least a portion of the first message comprises enabling the sender to accept responsibility to pay for the reply message.

7. The method of claim 1 further comprising charging at least one of a first account associated with the recipient and a second account associated with the sender for generation and presentation of the reply message.

8. The method of claim 1 wherein the recipient is one of a plurality of recipients to whom a copy of the first message has been presented and the reply option provided, the method further comprising facilitating generation of at least one additional reply message directed to the sender for at least one of the plurality of recipients.

9. The method of claim 8 further comprising presenting the reply messages to the sender sequentially in response to detection of a conflict between the reply messages.

10. The method of claim 1 wherein the first message comprises a survey including a plurality of queries, and wherein presenting the first message comprises presenting the queries in a sequence to the recipient, and wherein facilitating generation of at least a portion of the reply message comprises enabling the recipient to provide responses to the queries.

11. The method of claim 10 further comprising capturing the responses by enabling recording of at least one of speech of the recipient captured by the communication device, text entered by the recipient using the communication device, and signals generated by the recipient using the communication device.

12. The method of claim 10 further comprising aggregating the responses from the recipient with additional responses from additional recipients of the first message, and providing the aggregated responses to the sender.

13. The method of claim 1 wherein the communication device comprises a phone handset associated with the recipient, and wherein facilitating generation of at least a portion of the reply message comprises enabling recording of at least one of speech of the recipient captured by the phone handset, text entered by the recipient using the phone handset, and tones generated by the recipient using the phone handset.

14. A computer-implemented method for handling collisions in a system for delivering suspended messages, comprising:
storing a plurality of messages for delivery to a plurality of recipients, each of the messages having a delivery time associated therewith at which the associated message is to be presented to the corresponding recipient; and
where presentation of a first one of the messages to a first one of the recipients at the associated delivery time will result in a conflict with a second one of the messages directed to the first recipient, presenting the first and second messages to the first recipient sequentially.

15. The method of claim 14 wherein presenting the first and second messages sequentially comprises automatically selecting one of the first and second messages for presentation to the first recipient and storing the other of the first and second messages for subsequent presentation to the recipient.

16. The method of claim 14 wherein presenting the first and second messages sequentially comprises enabling the first recipient to select an order of presentation for the first and second messages.

17. The method of claim 16 wherein enabling the first recipient to select the order of presentation comprises storing the first and second messages in a voice library corresponding to the first recipient, and enabling access to the voice library by the first recipient.

18. A computer-implemented method for providing information regarding pending messages in a system for delivering suspended messages, the system storing a plurality of messages for delivery to a plurality of recipients, each of the messages having a delivery time associated therewith at which the associated message is to be presented to the corresponding recipient, the method comprising enabling a first one of the recipients to retrieve pending message information representing a first one of the messages directed to the first recipient, the pending message information including the delivery time associated with the first message, but not including message content associated with the first message.

19. The method of claim 18 wherein the pending message information further represents for the first message any of a sender identifier, a message size, message type, and a communication device to which the first message is directed.

20. The method of claim 18 further comprising enabling the first recipient to alter at least one parameter affecting presentation of the first message, the at least one parameter relating to any of the delivery time associated with the first message, a communication channel by which the first message is to be presented, and the format of the first message.

21. An electronic system for delivering suspended messages, comprising at least one holding system operable to store a plurality of messages for delivery to a plurality of recipients, each of the messages having a delivery event associated therewith occurrence of which results in the associated message being presented to the corresponding recipient, each holding system being further operable to detect changes in conditions affecting presentation of selected ones of the messages which occur between creation of the selected messages and occurrence of the corresponding delivery events, and facilitate presentation of the selected messages in a manner reflecting the changes in conditions.

22. The system of claim 21 wherein the changes in conditions relate to any of voicing systems, account balances, account validity, delivery costs, coding schemes, storage technologies, communication systems, regulations, and recipient locations.

23. The system of claim 22 wherein the holding system is operable to facilitate presentation of the selected messages by any of changing delivery times for the selected messages, canceling presentation of the selected messages, changing communication systems by which the selected messages are presented, changing amounts billed for presentation of the selected messages, changing formats of the selected messages, and changing coding schemes of the selected messages.

24. The system of claim 21 wherein the delivery event corresponds to at least one of a synchronous event and an asynchronous event.

25. The system of claim 21 further comprising a plurality of delivery systems, each delivery system being operable to facilitate presentation of the messages via a corresponding communication provider by normalizing interoperation of communication systems corresponding to the communication providers with the holding system.

26. The system of claim 25 wherein at least one of the changes relates to a first communication provider, and wherein the corresponding delivery system is operable to communicate the at least one of the changes to the holding system.

27. The system of claim 25 wherein each of the delivery systems is operable to normalize interoperation between the corresponding communication system and the holding system with regard to any of call setup, message playback, message recording, and message billing.

28. The system of claim 21 wherein the holding system is operable to facilitate presentation of the selected messages in a manner reflecting the changes in conditions automatically according to a predefined rule set.

29. The system of claim 21 wherein the holding system is operable to facilitate presentation of the selected messages in a manner reflecting the changes in conditions by notifying senders associated with the selected messages about the changes in conditions, and responding to input from the senders relating to the selected messages.

30. The system of claim 21 wherein the holding system is operable to generate an audit trail representing each of the messages.

31. The system of claim 21 further comprising at least one transformation system operable to transform the messages from a first format to a second format, the first and second formats corresponding to any of voice, text, and encoding schemes.

32. The system of claim 21 further comprising at least one event source system operable to indicate occurrence of at least some of the delivery events.
